(19) United States
(12) Patent Application Publication
(10) Pub. No.: US 2025/0326679 A1
(43) Pub. Date: Oct. 23, 2025

(54) MANUFACTURING METHOD OF OPTICAL FIBER BASE MATERIAL

(71) Applicant: Shin-Etsu Chemical Co., Ltd., Tokyo (JP)

(72) Inventor: Naoto Noda, Ibaraki (JP)

(73) Assignee: Shin-Etsu Chemical Co., Ltd., Tokyo (JP)

(21) Appl. No.: 19/175,721

(22) Filed: Apr. 10, 2025

(30) Foreign Application Priority Data
Apr. 18, 2024 (JP) 2024-067827

(51) Int. Cl. C03B 37/018

(52) U.S. Cl. CPC C03B 37/01853; C03B 2205/40; C03B 2207/36

(57) ABSTRACT

A manufacturing method of porous glass base material for optical fiber with suppressed characteristic fluctuation in the longitudinal direction is provided. A manufacturing method of optical fiber base material by the VAD method includes: detecting a tip position of a porous glass base material during deposition; controlling the pull-up speed to keep the tip position constant; in an early stage of deposition, a target pull-up speed is set for each deposition time, and a raw material gas flow rate to the burner is adjusted and corrected at a predetermined correction interval to achieve the target pull-up speed, thereby depositing while gradually changing the pull-up speed until a predetermined time; in a steady state, the deposition is performed such that the pull-up speed is kept constant to form the porous glass base material; and the porous glass base material is dehydrated and vitrified into transparent glass in a heating furnace.

### CROSS-REFERENCE TO RELATED APPLICATION

This non-provisional application claims priority under 35 U.S.C. § 119(a) from Japanese Patent Application No. 2024-067827, filed on Apr. 18, 2024, the entire contents of which are incorporated herein by reference.

### TECHNICAL FIELD

The present invention relates to a manufacturing method of optical fiber base metal by the VAD method, and in particular, to a manufacturing method of optical fiber base metal in which the characteristic fluctuation in the longitudinal direction of the optical fiber base metal can be suppressed.

### BACKGROUND ART

In the VAD method, combustible and auxiliary gases are fed into a burner to generate an oxyhydrogen flame, and raw material gases such as silicon tetrachloride or germanium tetrachloride are introduced into this flame to produce glass particles through a hydrolysis reaction. The generated glass particles are deposited in the axial direction of a starting member attached to a shaft that rises while rotating, thereby growing the glass particle deposit into a cylindrical shape and forming a porous glass base material. The obtained porous glass base material is then dehydrated and vitrified into transparent glass in a heating furnace to make glass base material for optical fiber.

As a method of suppressing characteristic fluctuation in the longitudinal direction of optical fiber glass base material manufactured by the VAD method, a method of varying the gas flow rate introduced into a burner according to the pull-up speed (see JP 2000-034131A) and a method of varying the position and flow rate of the burner based on the shape of the deposit (see JP H09-227147A) have been disclosed.

### SUMMARY OF THE INVENTION

### Problem to be Solved by the Invention

In such a manufacturing process, it is desirable to stabilize the optical characteristics of the optical fiber base material so that the tip position of a core soot is constant during the deposition by the VAD method. The optical characteristics here are cutoff wavelength, mode field diameter, dispersion characteristics, etc. The tip position of the core soot is detected by a CCD camera or similar device, and the pull-up speed or material gas flow rate to the burner is generally adjusted successively to keep the position constant. If large fluctuations occur in the pull-up speed or the flow rate of the raw material gas, the deposition state changes, and the characteristic fluctuations of the optical fiber base material also increase.

The present invention was made in view of the above problem, and it is an object of the present invention to provide a manufacturing method of a porous glass base material for optical fiber with suppressed characteristic fluctuation in the longitudinal direction.

### Means for Solving the Problem

In order to solve the above problem, the manufacturing method of optical fiber base material by the VAD method comprises steps of: detecting a tip position of a porous glass base material during deposition; controlling pull-up speed to keep the tip position constant; in an early stage of deposition, a target pull-up speed is set for each deposition time, and a raw material gas flow rate to the burner is successively adjusted and corrected to achieve the target pull-up speed, thereby depositing while gradually changing the pull-up speed until a predetermined time; in a steady state, the deposition is performed in a manner that the pull-up speed is kept constant to form the porous glass base material; and the porous glass base material is dehydrated and vitrified into transparent glass in a heating furnace to obtain the optical fiber glass base material.

In the present invention, in the manufacturing method of porous glass base material, the predetermined time for gradually changing the pull-up speed may be from the start of deposition to 300-500 minutes.

In the present invention, in the manufacturing method of porous glass base material, a correction interval of the raw material gas flow rate to the burner in the early stage of deposition may be 15 to 300 seconds.

In the present invention, in the manufacturing method of porous glass base material, the correction interval of the raw material gas flow rate to the burner in the early stage of deposition may be 30 to 90 seconds.

In the present invention, the optical fiber base material may be measured with a refractive index distribution measuring device to calculate and estimate the cutoff wavelength in the longitudinal direction, and based on the results obtained, the deposition condition may reflect a decrease in the target pull-up speed at the early stage of deposition if the cutoff wavelength on the starting side of deposition is to be increased and an increase in the target pull-up speed at the early stage of deposition if the cutoff wavelength on the start of deposition is to be reduced.

### Effects of the Invention

According to the present invention, it is possible to manufacture a porous glass base material for optical fiber with suppressed characteristic fluctuation in the longitudinal direction.

### BRIEF DESCRIPTION OF THE DRAWINGS

FIG. 1 shows an example of a manufacturing apparatus for core soot.

FIG. 2 shows the pull-up speed in the early stage of deposition in Examples 1-3 and Comparative Example 1.

FIG. 3 shows the cutoff wavelengths at longitudinal positions of the core base material in Example 1.

FIG. 4 shows the cutoff wavelengths at longitudinal positions of the core base material in Example 2.

FIG. 5 shows the cutoff wavelengths at longitudinal positions of the core base material in Example 3.

FIG. 6 shows the cutoff wavelengths at longitudinal positions of the core base material in Comparative Example 1.

### EMBODIMENTS OF THE INVENTION

In the following, an embodiment of the present invention is described with reference to the drawings. In the following descriptions and drawings, the same portion will be marked with the same reference numerals and the description of the portion once described will be omitted, or described only to the extent necessary.

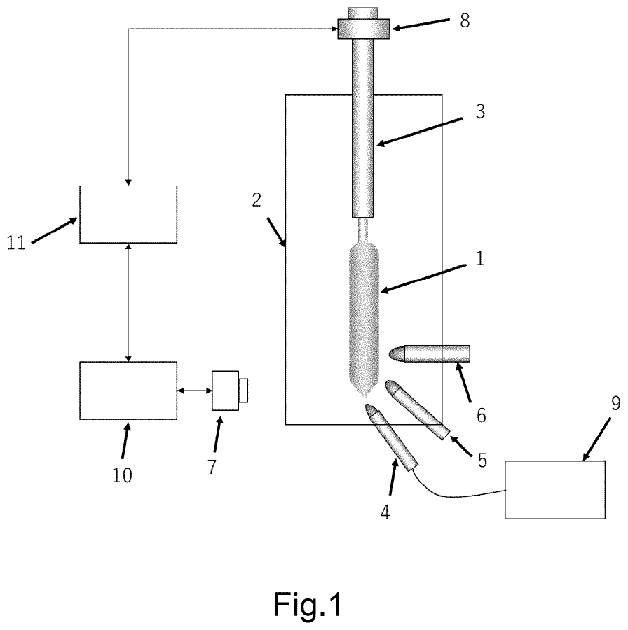

FIG. 1 shows an example of a manufacturing apparatus for core soot. The manufacturing apparatus is a manufacturing apparatus for optical fiber base material using the so-called VAD method. As shown in FIG. 1, the manufacturing apparatus includes a chamber 2 in which core soot (porous glass base material) 1 is formed, a shaft 3 suspended internally from the upper part of the chamber 2, a core forming burner 4, cladding forming burners 5 and 6 located in the lower part of the chamber 2, and a CCD camera 7 located outside the chamber 2 to capture images of the lower end of the core soot 1. The manufacturing apparatus further includes an elevating and rotating device 8 that elevates and rotates the shaft 3, a mass flow controller (MFC) 9 that controls the flow rate of the raw material gas, an image processor 10 that processes the image signal of the camera image of the lower end of the core soot 1, and a controller 11 that controls the operation of the various components. In the manufacturing of core soot 1, the pull-up speed is adjusted under the control of controller 11 so that the position of the lower end of core soot 1, as captured by CCD camera 7, is constant. Furthermore, the controller 11 includes means for calculating the average value of the pull-up speed at each predetermined time interval, means for calculating the difference between the calculated average value of the pull-up speed and the predetermined pull-up speed, and means for correcting the flow rate of the raw material gas supplied to the core forming burner 4 in accordance with the calculated difference.

In the steady state of deposition, it is desirable to pull up at a predetermined constant pull-up speed. On the other hand, in the early stage of deposition, deposition is not stable, and there are often differences in gas flow rate to the burner 4, settings of the burner 4, differences among individual burners 4 and apparatuses, and changes in the burner 4 over time, resulting in apparatus differences and lot differences in the pull-up speed transition.

In order to suppress fluctuations in optical characteristics in the longitudinal direction of the optical fiber base material, especially in the early stage of deposition, the present invention sets a target pull-up speed for each deposition time and gradually changes the pull-up speed by successively adjusting and correcting the raw material gas flow rate to burner 4 to achieve the target pull-up speed to deposit the soot. In this way, the pull-up speed in the early stage of deposition is stabilized and lot-to-lot variation is suppressed, thereby reducing lot-to-lot variation in characteristic fluctuation. In addition, the target pull-up speed in the early stage of deposition can be adjusted for each apparatus and lot. By adjusting the target pull-up speed in the early stage of deposition, it is possible to control the characteristic fluctuation of the glass base material in the longitudinal direction. The target pull-up speed may be set for each deposition time or according to the pull-up length of the core soot.

It is preferable to set a target pull-up speed for each deposition time and gradually change the pull-up speed by successively adjusting and correcting the raw material gas flow rate to burner 4 to achieve the target pull-up speed, which should be done in the time from the start of deposition to 500 minutes. Even more preferably, it should be done in the time from the start of deposition to 300 minutes. The duration for gradually adjusting the pull-up speed to reach the target pull-up speed should be neither too long nor too short to suppress characteristic fluctuations. The above duration was determined to be the most suitable.

Regarding the correction interval of the raw material gas flow rate to burner 4 in the early stage of deposition, if the correction interval is too long, the averaging time to determine the correction flow rate will increase, and the tracking to the target pull-up speed will be worse. In a steady state with a constant pull-up speed and stable deposition, there is no problem even if the correction interval is relatively long. However, in the early stage of deposition, where the pull-up speed changes gradually, a long correction interval time is not desirable. If the correction interval is too short, the correction of the raw material gas flow rate is performed too frequently, and small fluctuations in the pull-up speed are likely to occur. Therefore, in the early stage of deposition, it is preferable to set the correction interval of the raw material gas flow rate from 15 to 300 seconds, and even more preferably from 30 to 90 seconds.

Cleaning or replacing the burner or changing the burner setting may change the deposition state, and the longitudinal fluctuation of the cutoff wavelength may change even if manufactured at the same pull-up speed in the early stage of deposition as before the change. In such cases, the optical fiber base material may be measured with a refractive index distribution measuring device to calculate and estimate the cutoff wavelength in the longitudinal direction, and the target pull-up speed in the early stage of deposition may be adjusted based on the results obtained. Assuming the starting side of deposition by the VAD method is the starting side of the product of core base material, the deposition condition reflects a decrease in the target pull-up speed at the early stage of deposition if the cutoff wavelength on the starting side of the product is to be increased and an increase in the target pull-up speed at the early stage of deposition if the cutoff wavelength on the start of product is to be reduced. In this way, the fluctuation of the cutoff wavelength can be suppressed. In particular, when it is desired to adjust the cutoff wavelength in the range from 0 mm to 100 mm from the product starting end, it is better to change the target pull-up speed in the range from 0 to 250 mm of pull-up length by the VAD method, and when it is desired to adjust the cutoff wavelength in the range from 100 mm to 200 mm of product starting end, it is better to change the target pull-up speed in the range from 250 to 500 mm of pull-up length by the VAD method.

In the following, Examples 1-3 and Comparative Example 1, which were conducted to confirm the effects of the present invention, are described.

### EXAMPLES

### Example 1

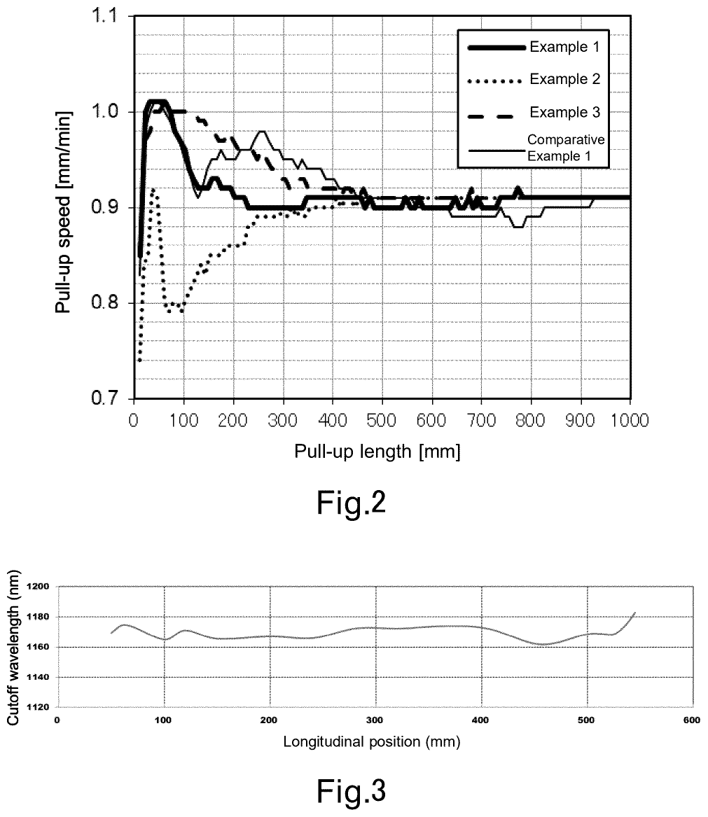

In deposition by the VAD method, silicon tetrachloride and germanium tetrachloride were supplied as glass raw materials to the core forming burner 4, and silicon tetrachloride was supplied as glass raw materials to the cladding forming burners 5 and 6. The target pull-up speed at 90 minutes after the start of deposition (pull-up length 85 mm) was set at 0.98 mm/min, the target pull-up speed at 120 minutes after the start of deposition (pull-up length 115 mm) was set at 0.94 mm/min, the target pull-up speed at 180 minutes after the start of deposition (pull-up length 170 mm) was set at 0.92 mm/min, the target pull-up speed at 240 minutes after the start of deposition (pull-up length 225 mm) was set at 0.90 mm/min, and the steady-state pull-up speed after 300 minutes from the start of deposition (pull-up length 280 mm) was set at 0.91 mm/min. The pull-up speed was gradually changed by successively adjusting and correcting the raw material gas flow rate to the core forming burner 4 to maintain the target pull-up speed at each time. The correction interval of the raw material gas flow rate to the core forming burner 4 was set to 30 seconds, and the deposition was performed. The thick solid line in FIG. 2 shows the pull-up speed in the early stage of deposition in Example 1. The final pull-up length of the core soot 1 was set at 1450 mm. The core soot 1 deposited by the VAD method was then heated in an electric furnace for dehydration and transparent vitrification to make transparent glass core base material. The product length of the core base material was 580 mm. The refractive index distribution of the core base material in the longitudinal direction was measured using a refractive index distribution measuring device, and optical characteristics such as cutoff wavelength and mode field diameter were calculated and estimated. The refractive index distribution of the core base material was calculated by incident a laser beam along a cross-section perpendicular to the axis of the base material and measuring the change in refractive angle in the plane. The finite element method was used to estimate and calculate the optical characteristics. FIG. 3 shows the cutoff wavelengths at longitudinal positions of the core base material in Example 1.

The starting side by the VAD method deposition was defined as the starting side of the core base material product, and the average value of the cutoff wavelength in the range of 200 to 400 mm from the starting end of the core base material product was obtained. The difference between the cutoff wavelength at each measurement point from 70 to 200 mm from the starting end and the average value obtained earlier was calculated at each point, and the sum of these values was divided by the number of measurement points. The value obtained in this way was defined as the cutoff wavelength fluctuation amount.

The fluctuation in cutoff wavelength was calculated for the core base material manufactured under the conditions of Example 1 and was 3.4 nm, which is very small as a fluctuation in cutoff wavelength.

### Example 2

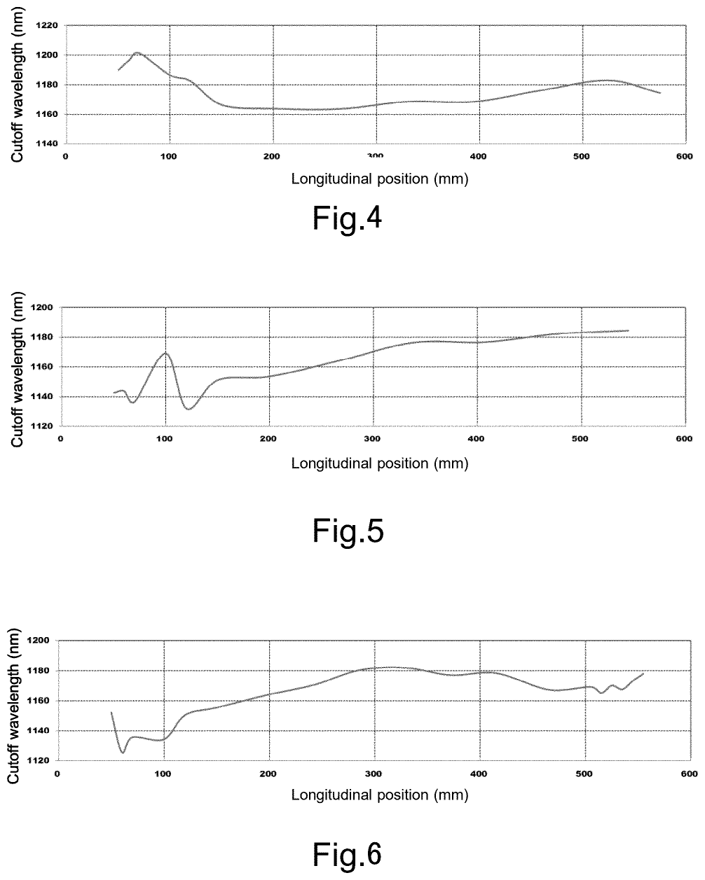

In deposition by the VAD method, silicon tetrachloride and germanium tetrachloride were supplied as glass raw materials to the core forming burner 4, and silicon tetrachloride was supplied as glass raw materials to the cladding forming burners 5 and 6. The target pull-up speed at 90 minutes after the start of deposition (pull-up length 75 mm) was set at 0.80 mm/min, the target pull-up speed at 120 minutes after the start of deposition (pull-up length 100 mm) was set at 0.80 mm/min, the target pull-up speed at 180 minutes after the start of deposition (pull-up length 150 mm) was set at 0.85 mm/min, the target pull-up speed at 240 minutes after the start of deposition (pull-up length 200 mm) was set at 0.87 mm/min, the target pull-up speed at 300 minutes after the start of deposition (pull-up length 250 mm) was set at 0.89 mm/min, and the steady-state pull-up speed after 540 minutes from the start of deposition (pull-up length 470 mm) was set at 0.91 mm/min. The pull-up speed was gradually changed by successively adjusting and correcting the raw material gas flow rate to the core forming burner 4 to maintain the target pull-up speed at each time. The correction interval of the raw material gas flow rate to the core forming burner 4 was set to 30 seconds, and the deposition was performed. After that, a core base material was obtained in the same way as in Example 1. The dotted line in FIG. 2 shows the pull-up speed in the early stage of deposition in Example 2. FIG. 4 shows the cutoff wavelengths at longitudinal positions of the core base material in Example 2.

The fluctuation in cutoff wavelength was calculated for the core base material manufactured under the conditions of Example 2 and was 14 nm. In Example 2, the target pull-up speed in the early stage of deposition was slower than that in Example 1, resulting in an increase in the cutoff wavelength on the starting side of the product.

### Example 3

In deposition by the VAD method, silicon tetrachloride and germanium tetrachloride were supplied as glass raw materials to the core forming burner 4, and silicon tetrachloride was supplied as glass raw materials to the cladding forming burners 5 and 6. The target pull-up speed at 90 minutes after the start of deposition (pull-up length 85 mm) was set at 1.00 mm/min, the target pull-up speed at 120 minutes after the start of deposition (pull-up length 115 mm) was set at 1.00 mm/min, the target pull-up speed at 180 minutes after the start of deposition (pull-up length 175 mm) was set at 0.97 mm/min, the target pull-up speed at 240 minutes after the start of deposition (pull-up length 230 mm) was set at 0.96 mm/min, the target pull-up speed at 300 minutes after the start of deposition (pull-up length 290 mm) was set at 0.93 mm/min, and the steady-state pull-up speed after 540 minutes from the start of deposition (pull-up length 510 mm) was set at 0.91 mm/min. The pull-up speed was gradually changed by successively adjusting and correcting the raw material gas flow rate to the core forming burner 4 to maintain the target pull-up speed at each time. The correction interval of the raw material gas flow rate to the core forming burner 4 was set to 30 seconds and the deposition was performed. After that, a core base material was obtained in the same way as in Example 1. The dashed line in FIG. 2 shows the pull-up speed in the early stage of deposition in Example 3. FIG. 5 shows the cutoff wavelengths at longitudinal positions of the core base material in Example 3.

The fluctuation in cutoff wavelength was calculated for the core base material manufactured under the conditions of Example 3 and was 21.4 nm. In Example 3, the target pull-up speed in the early stage of deposition was faster than that in Example 1, resulting in a decrease in the cutoff wavelength on the starting side of the product.

### Comparative Example 1

In deposition by the VAD method, silicon tetrachloride and germanium tetrachloride were supplied as glass raw materials to the core forming burner 4, and silicon tetrachloride was supplied as glass raw materials to the cladding forming burners 5 and 6. In Comparative Example 1, the target pull-up speed was not set for the early stage of deposition, and the raw material gas flow rate to the core forming burner 4 was set for each deposition time. The raw material gas flow rate at 90 minutes after the start of deposition (pull-up length 85 mm) was set at 440 sccm, the raw material gas flow rate at 120 minutes after the start of deposition (pull-up length 115 mm) was set at 500 sccm, the raw material gas flow rate at 180 minutes after the start of deposition (pull-up length 170 mm) was set at 585 sccm, the raw material gas flow rate at 240 minutes after the start of deposition (pull-up length 230 mm) was set at 620 sccm, the raw material gas flow rate at 300 minutes after the start of deposition (pull-up length 280 mm) was set at 620 sccm, and in the steady state after 500 minutes (pull-up length 550 mm) from the start of deposition, the raw material gas flow rate to the core forming burner 4 was successively adjusted and corrected so that the pull-up speed would be 0.91 mm/min. The correction interval of the raw material gas flow rate to the core forming burner 4 was set to 1200 seconds and the deposition was performed. After that, a core base material was obtained in the same way as in Example 1. The thin solid line in FIG. 2 shows the pull-up speed in the early stage of deposition in Comparative Example 1. FIG. 6 shows the cutoff wavelengths at longitudinal positions of the core base material in Comparative Example 1.

The fluctuation in cutoff wavelength was calculated for the core base material manufactured under the conditions of Comparative Example 1 and was 21.8 nm. In Comparative Example 1, the target pull-up speed was not set at the early stage of deposition, and the raw material gas flow rate to the core forming burner 4 was set for each deposition time and controlled so that the pull-up speed can be adjusted to reach the set flow rate, resulting in an unstable pull-up speed at the early stage of deposition and consequently a large fluctuation in the cut-off wavelength on the start side of the product.

As mentioned above, the longitudinal fluctuation of the cutoff wavelength in the early stage of deposition does not always show the same tendency, and the fluctuation may change due to burner cleaning and replacement, burner settings, or changes over time. In such cases, optical fiber preform may be manufactured to check the tendency of longitudinal fluctuation of cutoff wavelength, and the characteristics of the optical fiber preform may be measured using a refractive index distribution measuring device to calculate and estimate the cutoff wavelength in the longitudinal direction, and the target pull-up speed in the early stage of deposition may be adjusted based on the results obtained. From the results of the above Example 2, when the cutoff wavelength at the start end of the product is to be increased (i.e. when there is a tendency for the cutoff wavelength at the start end of the product to be lower than the cutoff wavelength thereafter), it is possible to suppress the fluctuation of the cutoff wavelength of the product as a whole by increasing the cutoff wavelength on the start end of the product by decreasing the target pull-up speed in the early stage of deposition. From the results of the above Example 3, the cutoff wavelength at the start end of the product is to be decreased (i.e., when there is a tendency for the cutoff wavelength at the start end of the product to be higher than the cutoff wavelength thereafter), it is possible to suppress the fluctuation of the cutoff wavelength of the product as a whole by decreasing the cutoff wavelength on the start end of the product by increasing the target pull-up speed in the early stage of deposition.

The present invention is not limited to the above embodiments. The above embodiments are examples, and any embodiment that has substantially the same configuration as the technical concept described in the claims of the present invention and achieves similar effects is included in the technical scope of the present invention. In other words, changes can be made as appropriate within the scope of the technical concept expressed in the present invention, and forms with such changes and improvements are included in the technical scope of the present invention.

What is claimed is:

1. A manufacturing method of optical fiber base material by the VAD method comprising steps of:
detecting a tip position of a porous glass base material during deposition; controlling the pull-up speed to keep the tip position constant;
in an early stage of deposition, a target pull-up speed is set for each deposition time, and a raw material gas flow rate to the burner is adjusted and corrected at a predetermined correction interval to achieve the target pull-up speed, thereby depositing while gradually changing the pull-up speed until a predetermined time;
in a steady state, the deposition is performed in a manner that the pull-up speed is kept constant to form the porous glass base material; and
the porous glass base material is dehydrated and vitrified into transparent glass in a heating furnace to obtain the optical fiber glass base material.

2. The manufacturing method of optical fiber base material according to claim 1, wherein the predetermined time for gradually changing the pull-up speed is from the start of deposition to 300-500 minutes.

3. The manufacturing method of optical fiber base material according to claim 1, wherein a correction interval of the raw material gas flow rate to the burner in the early stage of deposition is 15 to 300 seconds.

4. The manufacturing method of optical fiber base material according to claim 1, wherein a correction interval of the raw material gas flow rate to the burner in the early stage of deposition is 30 to 90 seconds.

5. The manufacturing method of optical fiber base material according to claim 1, wherein the optical fiber base material is measured with a refractive index distribution measuring device to calculate and estimate the cutoff wavelength in the longitudinal direction, and based on the results obtained, the deposition condition reflects a decrease in the target pull-up speed at the early stage of deposition if the cutoff wavelength on the starting side of deposition is to be increased and an increase in the target pull-up speed at the early stage of deposition if the cutoff wavelength on the start of deposition is to be reduced.
